(19) United States
(12) Patent Application Publication
(10) Pub. No.: US 2003/0185375 A1
(43) Pub. Date: Oct. 2, 2003

(54) Call transfer system and method

(76) Inventor: Nandakishore A. Albal, Naperville, IL (US)

Correspondence Address: MOTOROLA INC, 600 NORTH US HIGHWAY 45, LIBERTYVILLE, IL, 60048-5343, US

(21) Appl. No.: 10/401,913

(22) Filed: Mar. 28, 2003

Related U.S. Application Data
(63) Continuation of application No. 09/374,814, filed on Aug. 16, 1999.

(51) Int. Cl. H04M 7/00

(52) U.S. Cl. 379/220.01

(57) ABSTRACT

A system and method of transferring a call is provided. One method of transferring a call across networks of a transport system in accordance with the present invention includes the steps of connecting the first communication device to the communication node over a first network of the transport system and connecting the second communication device with the first communication device. The method includes establishing a connection between the third communication device and the communication node over a second network of the transport system and connecting the second communication device to the third communication device.

### FIELD OF THE INVENTION

The present invention relates generally to communication systems, and more particularly, to call transfer systems and methods.

### BACKGROUND OF THE INVENTION

Typically, Private Branch Exchanges (PBX) and some Public Switched Telephone Networks (PSTN) allow telephone calls to be “parked” and then transferred to another telephone within the same network. These networks typically reside in office environments, in which a number of telephones, each one usually having a designated line or extension, are linked together by a single, common telephone number. When a party or user desires to transfer the call from one telephone to another telephone, the party usually “parks” the call and then transfers it to the other telephone within the same network. The party may transfer the call by directing the network to transfer the call to another extension by using a preset keypad sequence on the telephone unit. The party can then resume the phone call after picking up the other telephone and allowing the call to transfer to the telephone.

However, this process may not be available to transfer calls across different telecommunication networks (i.e., from a PBX network to a cellular or Internet network.) For instance, a user may not be able to transfer a call from an office telephone (usually within a PBX) to another telephone outside of the office telephone's network, such as a cellular telephone within a cellular network. Accordingly, it would be desirable to allow a party who is engaged in a telephone call with another party to transfer the call to another communication device in a different network without reinitiating the call to the other party.

### BRIEF DESCRIPTION OF THE DRAWINGS

FIG. 1 is a block diagram of an embodiment of a communication system in accordance with the present invention;

FIG. 2 is a more detailed block diagram of one embodiment of the communication system of FIG. 1;

FIG. 3 is a flowchart that illustrates one embodiment of a call transfer routine in accordance with the present invention;

FIG. 4 is a flowchart that illustrates a subroutine of the call transfer routine of FIG. 3;

FIG. 5 is a flowchart that illustrates another subroutine of the call transfer routine of FIG. 3;

FIG. 6 is a flowchart that illustrates another subroutine of the call transfer routine of FIG. 3;

FIG. 7 is a flowchart that illustrates another subroutine of the call transfer routine of FIG. 3; and

FIG. 8 is an exemplary block diagram of another embodiment of a communication system in accordance with the present invention.

### DETAILED DESCRIPTION OF THE PRESENTLY PREFERRED EMBODIMENTS

FIG. 1 is a block diagram that illustrates an embodiment of a communication system 10. The communication system 10 generally includes one or more network access devices or communication devices 12, 14 (two being shown) and an electronic network 16. The communication system 10 can provide various services and capabilities to cellular subscribers, wire-line telephone subscribers, paging subscribers, satellite subscribers, mobile or portable telephone subscribers, trunked subscribers, computer network subscribers (e.g., Internet or Intranet subscribers), wireless data subscribers, branch office users and the like. For example, the communication system 10 can provide speech and/or touch-tone recognition, incoming call authorization, call routing, text-to-speech (TTS) and/or speech-to-text (STT) capabilities, call screening, interactive voice applications, etc. As further described below, the communication system 10 can also provide a party with various call transfer capabilities. For example, the communication system 10 allows a party to transfer a call to a communication device associated with another network. The communication system 10 further allows a party to place a call on hold and then be reconnected to the call by dialing into the system from another communication device.

The communication devices 12, 14 can be utilized by parties or subscribers to access and/or connect with the electronic network 16. The communication devices 12, 14 can include a variety of forms, including, for example, conventional telephones, mobile telephones, paging units, radio units, wireless data devices, web telephones, portable or wireless telephones, personal information managers (PIMs), personal digital assistants (PDAs), personal computers (PCs), network televisions (TVs), Internet TVs, Internet telephones, portable wireless devices, workstations or any other suitable communication devices. It is contemplated that the communication devices 12, 14 can be integrated with the electronic network 16.

The electronic network 16 is coupled to the communication device 12 via line 18, and to the communication device 14 via line 20. The lines 18, 20 may preferably include, for example, telephone lines, Integrated Services Digital Network (ISDN) lines, coaxial lines, cable television lines, fiber optic lines, computer network lines, digital subscriber lines, dedicated lines, pay or lease lines, virtual private network lines or the like. Alternatively, the communication devices 12, 14 can wirelessly communicate with the electronic network 16. For example, the electronic network 16 can communicate with the communication devices 12, 14 by either satellite or wireless communication systems, such as, for example, wireless local loop systems, including Local Multi-point Distribution Systems (LMDS) and Multi-channel Multi-point Distribution Systems (MMDS).

The electronic network 16 may include, for example, an Intranet, an Extranet, a Local Area Network (LAN), a telephone network, (e.g., a Public Switched Telephone Network (PSTN)), a cellular network, a personal communication system, a TV network (e.g., a cable TV system), a local, regional, national or global paging network, an e-mail system, a wireless data network (e.g., satellite data or local wireless data networks), a wireless LAN, a wireless local loop/distribution system (e.g., LMDS, MMDS or CDMA based system), a Voice Over Internet Protocol (VOIP) network, a communication node, etc. The electronic network 16 can also include a wide area network (WAN), such as, for example, the Internet, the World Wide Web (WWW) or any other similar on-line service.

Furthermore, the electronic network 16 can provide various calling capabilities to a subscriber. For example, the electronic network 16 can place a call to a particular contact at a selected location or device in response to voice commands or Dual-Tone Multiple-Frequency (DTMF) signals from the caller or subscriber (e.g., “Call Bob at home”, “Call Ann at work”, or “Dial Bill on mobile phone”). Alternatively, the caller or subscriber can specify a number to be dialed or called, such as, “Call 630-555-1212.”

Furthermore, a caller or subscriber can read or modify a personal file or address book stored in the electronic network 16 through the communication devices 12, 14. The address book preferably stores names of parties along with their addresses and telephone numbers. Once the subscriber accesses his or her personal address book, the electronic network 16 can read information about one or more of the parties stored in the address book and can provide various details to the subscriber (e.g., addresses, etc.). The subscriber can then call the party by using voice commands (e.g., “Call Bob”). The subscriber can also enter frequently dialed telephone numbers for voice activated dialing using voice commands. Additionally, the electronic network 16 will allow a subscriber to add a called number to the address book from a listing of previously called numbers made available from the billing records.

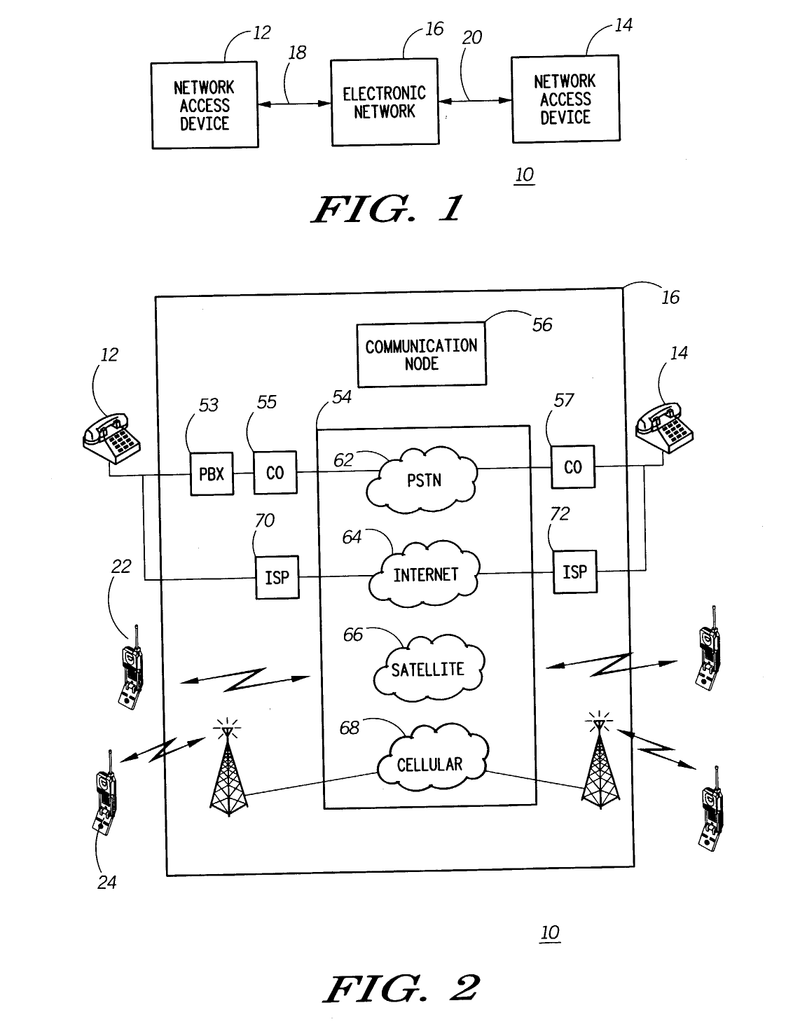

FIG. 2 illustrates a more detailed block diagram of one embodiment of the communication system 10 of FIG. 1. It will be recognized that the communication system can be implemented in various configurations. The communication node can include an electronic assistant to provide various instructions to the subscriber or caller and to respond to voice commands or DTMF tone from the caller as further described below. The communication system 10 can allow a call connected over a first network with a party's first communication device to be transferred or connected to the party's second communication device associated with a second network without the need for a party to reinitiate contact with the other party. For example, a party communicating over a land line telephone associated with a PSTN can instruct the communication node to transfer the call to his/her cellular telephone associated with a cellular network.

As shown in FIG. 2, the electronic network 16 includes a transport system 54 and a communication node 56. The transport system is preferably connected to the communication node via a high speed data link, such as a T1 telephone line, a local area network (LAN), or a wide area network (WAN). It is contemplated that the communication node 56 may be integrated within or may be remote from the transport system 54. An example of a communication node 56 is the MIX™ platform and the Myosphere™ Service provided by Motorola, Inc. of Schaumburg, Ill., as further described with reference to FIG. 8.

The transport system 54 routes incoming calls from the communication device 12 to the communication node 56 and routes outgoing calls from the communication node to the communication device 14. As illustrated in FIG. 2, the transport system 54 can include one or more networks, such as, a PSTN 62, an Internet network 64, a satellite network 66, a cellular network 68 and/or any other suitable network. As shown in FIG. 2, the first communication device 12 can be operatively connected to the PSTN 62 through a conventional Private Branch Exchange (PBX) 53 and a Central Office (CO) 55 of a carrier. Similarly, the communication device 14 can be operatively connected to the PSTN of the transport system 54 through the CO 57 of a carrier. An Internet Service Provider (ISP) 70 can also operatively connect the communication device 12 to the Internet network 64. Similarly, the ISP 72 operatively can connect the Internet network 64 to the communication device 14. Likewise, cellular or mobile phones can be connected to the cellular network by cellular base stations, and satellite phones can be connected to the satellite network via a suitable satellite system (not shown).

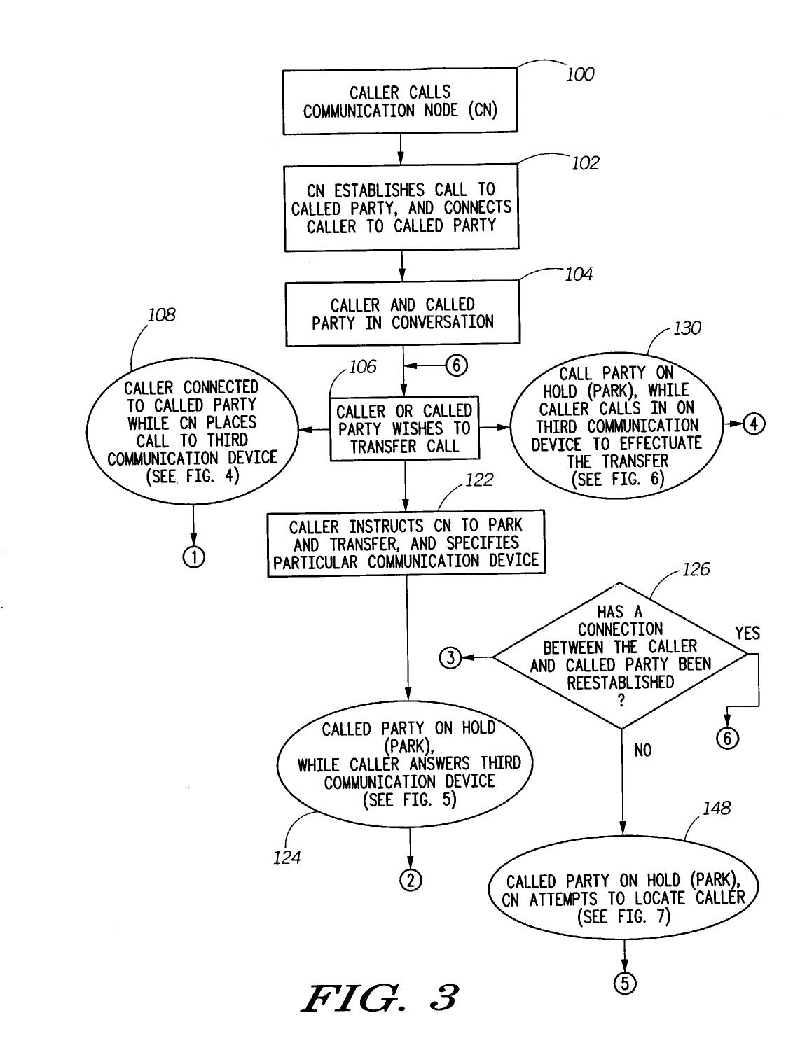

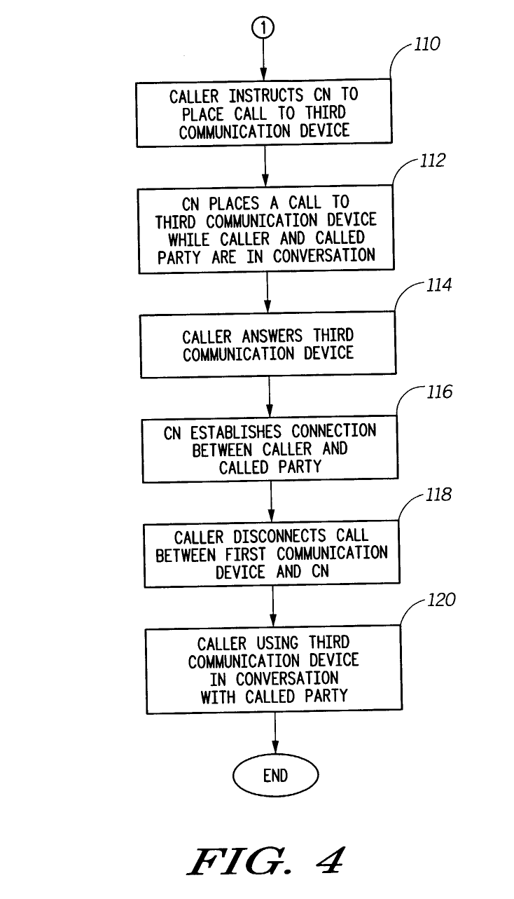

FIGS. 3-7 show block diagrams of a call transfer routine carried out by the communication system 10 to allow a party or subscriber to transfer a call across communication networks. At block 100, a caller or subscriber places an incoming call to the communication node from a communication device. The incoming call is routed through a first network of the transport system 54 to the communication node 56. After the communication node or an electronic assistant answers the incoming call, the caller can place an outgoing call to another party (i.e., a called party) based upon commands from the caller at block 102. The communication node can then connect or link the incoming call to the outgoing call to allow the caller to communicate with the called party at block 104. Alternatively, the caller can directly dial the phone number of the called party and the communication node or transport system can automatically route the call to the called party.

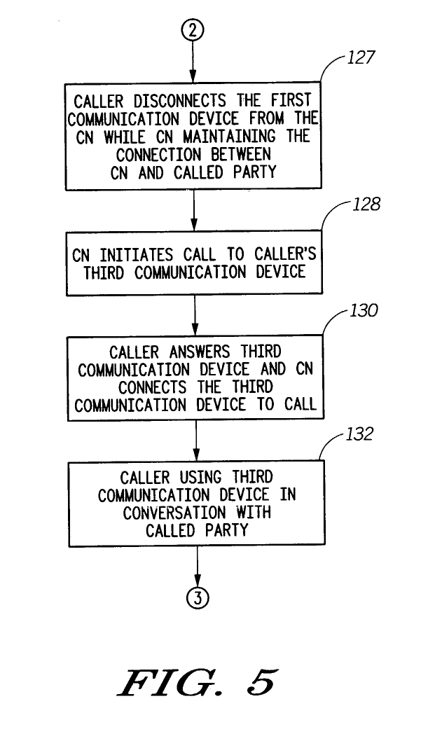

At block 106, the caller or called party decides to transfer the call to another communication device associated with another network of the transport system. The communication node can allow a caller or called party to transfer a call in various ways. If the party wishes to transfer the call while remaining in communication with the other party, the call transfer routine proceeds to subroutine 108, as further shown in FIG. 4. It will be recognized that both the caller and called party may transfer the call to another communication device. Therefore, for convenience, only the situation where the caller transfers a call will be described below.

As shown in FIG. 4, at block 110, the caller initially instructs the communication node 56 or the electronic assistant to place a call to another of his/her communication devices (i.e., a third communication device) associated with a second network of the transport systems 54. For example, the caller can instruct the communication node to transfer the call through voice commands (i.e., “transfer the call to my mobile phone”), DTMF tones, or another similar predetermined commands. Alternatively, the call may be transferred using out-of-band signaling. For example, the user may instruct the communication node 56 to transfer the call through commands sent over another network (i.e., the internet or other suitable network) by another communication device (i.e., a computer). For instance, the caller may be communicating with the called party via a telephone call and out-of-band send commands or signals to the communication node over the internet through his/her computer to transfer the call.

At block 112, the communication node 56 places a call to the third communication device via the second network of the transport system 68 while the caller and the called party remain in communication with each other. Once the caller answers the call placed to the third communication device at block 114, the communication node 56 connects the caller via the third communication device to the called party at block 116. The communication node then disconnects the original connection established between the caller and the communication node at block 118. At block 120, the caller and the called party can communicate with each other. This process can also be utilized to additional parties to the call. For example, the caller may instruct the communication node to call another party on the same or another network (i.e., call Susan on Mobile phone or dial 888-123-4567) to establish a three-way conference call between the caller, the called party, and the new party. The communication node can access the address book of the caller to determine the party's number (i.e., Susan) and then call the party.

Referring again to FIG. 3, if the caller desires place the call on hold and then transfer the call to another or third communication device associated with a second network at block 106, the caller can instruct the communication node to park the call and to transfer the call to the third communication device at block 122 (i.e., “please transfer the call to my cell phone”). The call transfer routine then proceeds to subroutine 124, as shown in reference to FIG. 5.

As shown in FIG. 5, when the caller parks the call at block 127, the communication node disconnects the connection between the caller's communication device and the communication node, while maintaining the connection between the communication node 56 and the called party. At block 128, the communication node places a call through a second network of the transfer system to the third communication device. Once the caller answers the third communication device, the communication node connects the caller via the third communication device to the called party at block 130. At block 132, the caller is again in communication with the called party. If the caller does not answer the call within a certain time period, the call transfer routine then proceeds to block 126 as further described below.

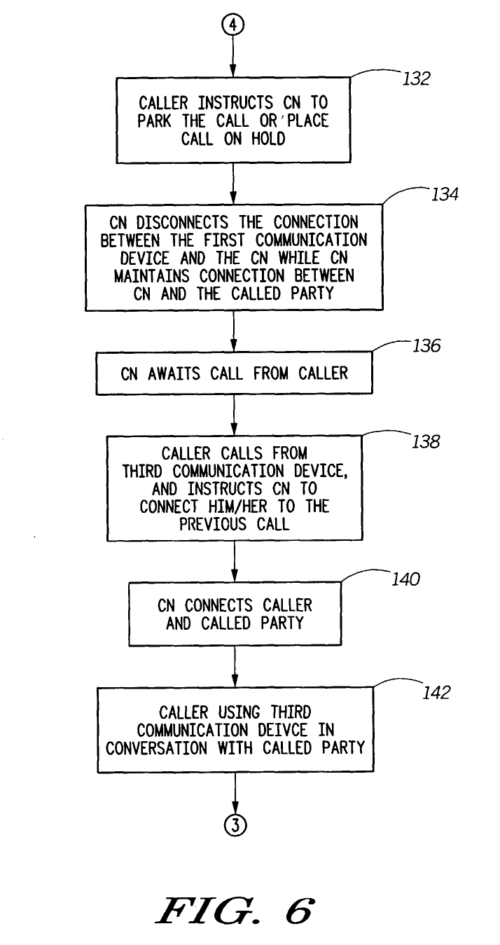

Referring again to FIG. 3, if the caller desires place the call on hold and call back into the communication node with another or third communication device associated with another network at block 106, the call transfer routine proceeds to subroutine 130, as further described below in reference to FIG. 6.

As shown in FIG. 6, the caller instructs the communication node to park the call or place the call on hold at block 132 (i.e., “please put the call on hold”). It should be noted the caller may notify the communication node or the electronic assistant about transferring the call (i.e., “I will be calling back on another phone”). At block 134, the communication node disconnects the connection between the caller and the communication device while maintaining the connection between the communication node and the called party. The communication node then waits for a call from the caller at block 136.

Once the caller calls into the communication node on the third communication device, the node answers the call and the caller can instruct the communication node to connect him/her to the called party at block 138 (i.e., “connect me to my previous call” or “connect me with Bob” (the called party)). After the node connects the caller to the called party at block 140, the caller can communicate with the called party at block 142. This feature may be useful in situations in which the caller does not know to which device the communication node should direct the call. If the caller does not call into the node within a certain time period, the call transfer routine proceeds to block 126 of FIG. 3.

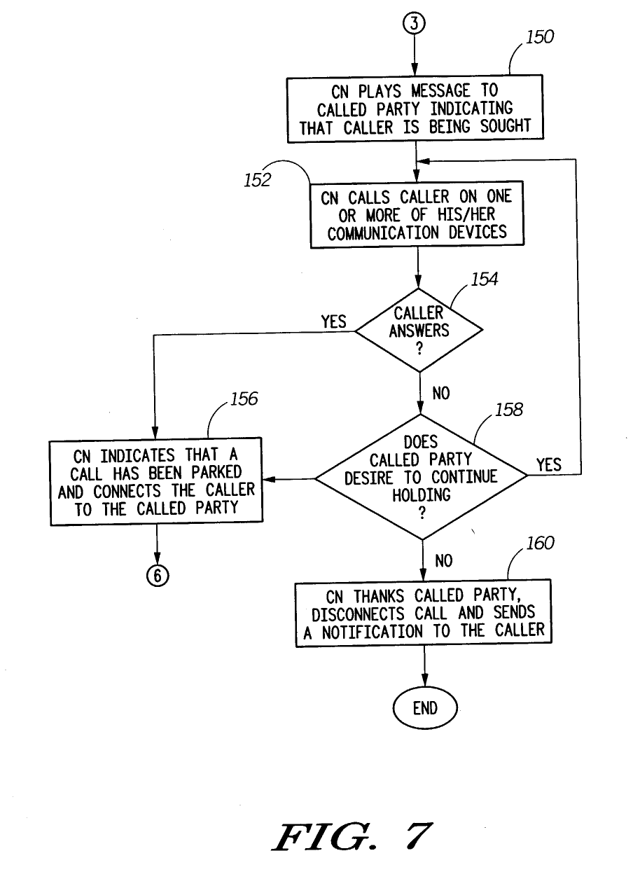

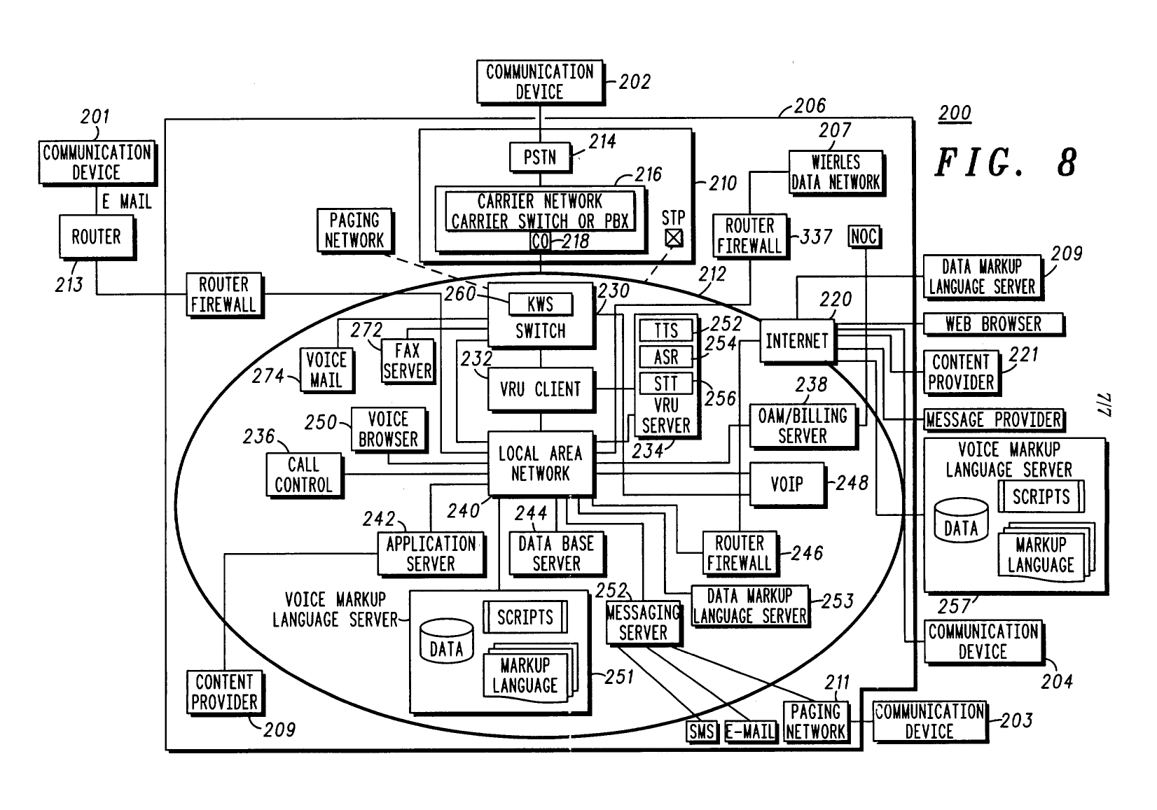

As shown in FIG. 3, the communication node determines whether a connection has been re-established between the caller and the called party at block 126. If the caller has been reconnected to the call, the call transfer routine proceeds to block 144. If, after a specified amount of time, the caller has not been re-connected to the call, the communication node 56 will attempt to locate the subscriber and proceed to subroutine 148, as further described below in reference to FIG. 7.

As shown in FIG. 7, the communication node 56 notifies the called party of the status of the communication node 56 (i.e., “attempting to contact the caller”) at block 150. At block 152, the communication node 56 attempts to call the caller on one of his/her communication devices. If the caller answers the call at block 154, the communication node indicates that he/she has a parked call or a call on hold and connects the caller to the called party, thus re-establishing the communication between the called party and the caller at block 156. If the subscriber does not answer the call from the communication node, the communication node then asks the called party if he/she would like to continue holding at block 158. If the called party does not desire to continue holding, the communication node disconnects the called party from the communication node and sends a notification about the abandon call to the caller to one of the caller's communication devices (i.e., computer, email system, paging unit, phone, etc.) at block 160; otherwise, the communication node 56 will and again attempt to locate the subscriber at block 152. Although the situation where the caller transfers the call to the another communication device has been described above, it will be recognized that the called party can also transfer a call in the same or similar manner.

Referring now to FIG. 8, an exemplary block diagram of another embodiment of a communication system 200 having the capability to transfer calls across various networks is illustrated. The communication system 200 of FIG. 8 can carry out the call transfer routine shown in FIGS. 3-7 to allow a party to transfer a call. For example, the communication node can transfer a call from a communication device connected through the PSTN of the telecommunication network to a communication device associated with a wireless data network.

The communication system 200 generally includes one or more communication devices or network access devices 201, 202, 203, 204, 205 (five being shown), an electronic network 206, and one or more information sources (e.g., content providers 208, 221 (two being shown) and data and voice markup language servers 209, 251, 253, 257). The communication devices can be the same or similar to the communication devices described in reference to FIGS. 1 and 2. Accordingly, further description of the communication devices is unnecessary for a complete understanding of the present embodiment. The user or subscriber can access the electronic network 206 by dialing a single direct access telephone number (e.g., a foreign exchange telephone number, a local telephone number, or a toll-free telephone number or PBX) from the communication device 202. The subscriber can also access the electronic network 206 from the communication device 204 via the Internet or WWW, from the communication device 203 via a paging network 211, or from the communication device 201 via a local area network (LAN), wireless data network, a wide area network (WAN), or an e-mail connection. It will be recognized that the system can be accessed in various ways depending on the configuration of the system.

As shown in FIG. 8, the electronic network 206 of the system 200 includes a telecommunication network 210 and a communication node 212. The telecommunication network 210 is preferably connected to the communication node 212 via a high-speed data link, such as, a T1 telephone line, a local area network (LAN), a wide area network (WAN) or a VOIP network. The telecommunication network 210 preferably includes a public switched network (PSTN) 214 and a carrier network 216. The telecommunication network 210 can also include international or local exchange networks, a cable television network, interexchange carrier networks (IXC) or long distance carrier networks, cellular networks (i.e., mobile switching centers (MSC)), PBXs, satellite systems, wireless data networks, and other switching centers such as conventional or trunked radio systems (not shown), etc. The electronic network can also include additional telecommunication networks, such as a wireless data network 207 or any of the networks or systems described above.

The PSTN 214 of the telecommunication network 210 can include various types of communication equipment or apparatus, such as ATM networks, Fiber Distributed data networks (FDDI), T1 lines, cable television networks, VOIP networks and the like. The carrier network 216 of the telecommunication network 210 generally includes a telephone switching system or central office 218. It will be recognized that the carrier network 216 can be any suitable system that can route calls to the communication node 212, and the telephone switching system 218 can be any suitable wireline or wireless switching system.

The communication node 212 the system 200 is preferably configured to receive and process incoming calls from the carrier network 216 and the Internet 220, such as the WWW. The communication node can receive and process pages from the paging network 211 and can also receive and process messages (i.e., e-mails) from the LAN, WAN, wireless data network or e-mail connection 213.

When a user dials into the electronic network 206 from the communication device 202, the carrier network 216 routes the incoming call from the PSTN 214 to the communication node 212 over one or more telephone lines or trunks. The incoming calls preferably enters the carrier network 216 through one or more “888” or “800” INWATS trunk lines, local exchange trunk lines, or long distance trunk lines. It is also contemplated that the incoming calls can be received from a cable network, a cellular system, VOIP network or any other suitable system.

The communication node 212 answers the incoming call from the carrier network 216 and retrieves an appropriate announcement (i.e., a welcome greeting) from a database, server, or browser. The node 212 then plays the announcement to the caller. In response to audio inputs from the user, the communication node 212 retrieves information from a destination or database of one or more of the information sources, such as the content providers 208 and 221 or the voice or data markup language servers 209, 251, 253 and 257. After the communication node 212 receives the information, the communication node provides a response to the user based upon the retrieved information.

The node 212 can provide various dialog voice personalities (i.e., a female voice, a male voice, etc.) and can implement various grammars (i.e., vocabulary) to detect and respond to the audio inputs from the user. In addition, the communication node can automatically select various speech recognition models (i.e., an English model, a Spanish model, an English accent model, etc.) based upon a user profile, the user's communication device, and/or the user's speech patterns. The communication node 212 can also allow the user to select a particular speech recognition model.

When a user accesses the electronic network 206 from a communication device registered with the system (i.e., a user's home phone, work phone, cellular phone, etc.), the communication node 212 can by-pass a user screening option and automatically identify the user (or the type of the user's communication device) through the use of automatic number identification (ANI) or caller line identification (CLI). After the communication node verifies the call, the node provides a greeting to the user (i.e., “Hi, this is your personal agent, Maya. Welcome Bob. How may I help you?”). The communication node then enters into a dialogue with the user, and the user can select a variety of information offered by the communication node.

When the user accesses the electronic network 206 from a communication device not registered with the system (i.e., a payphone, a phone of a non-subscriber, etc.), the node answers the call and prompts the user to enter his or her name and/or a personal identification number (PIN) using speech commands or DTMF tones. The node can also utilize speaker verification to identify a particular speech pattern of the user. If the node authorizes the user to access the system, the node provides a personal greeting to the user (i.e., “Hi, this is your personal agent, Maya. Welcome Ann. How may I help you?”). The node then enters into a dialogue with the user, and the user can select various information offered by the node. If the name and/or PIN Number of the user cannot be recognized or verified by the node, the user will be routed to a customer service representative.

Once the user has accessed the system, the user may implement a wide variety of services and features by using voice commands, such as, for example, voice dialing, voice paging, facsimiles, caller announcements, voice mails, reminders, call forwarding, call recording, content information (i.e. newspapers, etc.), read e-mail, read calendars, read “to-do” lists, banking, v-commerce, e-commerce, etc. The system can place outbound calls and pages to business and personal parties or contacts (i.e., friends, clients, business associates, family members, etc.) in response to DTMF tones or speech commands. The calls can be routed through a telephone or electronic network to the selected party and the pagers can be sent to a selected party via a paging system. The system can also receive calls routed through a telephone or electronic network.

As shown in FIG. 8, the communication node 212 preferably includes a telephone switch 230, a voice or audio recognition (VRU) client 232, a voice recognition (VRU) server 234, a controller or call control unit 236, an Operation and Maintenance Office (OAM) or a billing server unit 238, a local area network (LAN) 240, an application server unit 242, a database server unit 244, a gateway server or router firewall server 246, a voice over internet protocol (VOIP) unit 248, a voice browser 250, a voice markup language server 251, a messaging server 255, and a data markup language server 253. Although the communication node 212 is shown as being constructed with various types of independent and separate units or devices, the communication node 212 can be implemented by one or more integrated circuits, microprocessors, microcontrollers, or computers which may be programmed to execute the operations or functions equivalent to those performed by the device or units shown. It will also be recognized that the communication node 212 can be carried out in the form of hardware components and circuit designs, software or computer programming, or a combination thereof.

The communication node 212 can be located in various geographic locations throughout the world or the United States (i.e., Chicago, Ill.). The communication node 212 can be operated by one or more carriers (i.e., Sprint PCS, Qwest Communications, MCI, etc.) or independent service providers, such as, for example, Motorola, Inc.

The communication node 212 can be co-located or integrated with the carrier network 216 (i.e., an integral part of the network) or can be located at a remote site from the carrier network 216. It is also contemplated that the communication node 212 may be integrated into a communication device, such as, a wireline or wireless phone, a radio device, a personal computer, a PDA, a PIM, etc. In this arrangement, the communication device can be programmed to connect or link directly into an information source.

The communication node 212 can also be configured as a standalone system to allow users to dial directly into the communication node via a toll free number or a direct access number. In addition, the communication node 212 may comprise a telephony switch (i.e., a PBX or Centrix unit), an enterprise network, or a local area network. In this configuration, the system 200 can be implemented to automatically connect a user to the communication node 212 when the user picks a communication device, such as, the phone.

When the telephone switch 230 of the communication node 212 receives an incoming call from the carrier network 216, the call control unit 236 sets up a connection in the switch 230 to the VRU client 232. The communication node 212 then enters into a dialog with the user regarding various services and functions. The VRU client 232 preferably generates pre-recorded voice announcements and/or messages to prompt the user to provide inputs to the communication node using speech commands or DTMF tones. In response to the inputs from the user, the node 212 retrieves information from a destination of one of the information sources and provides outputs to the user based upon the information.

The telephone switch 230 of the telecommunication node 212 is preferably connected to the VRU client 232, the VOIP unit 248, and the LAN 240. The telephone switch 230 receives incoming calls from the carrier switch 216. The telephone switch 230 also receives incoming calls from the communication device 204 routed over the Internet 220 via the VOIP unit 248. The switch 230 also receives messages and pages from the communication devices 201 and 203, respectively. The telephone switch 230 is preferably a digital cross-connect switch, Model No. LNX, available from Excel Switching Corporation, 255 Independence Drive, Hyannis, Mass. 02601. It will be recognized that the telephone switch 230 can be any suitable telephone switch.

The VRU client 232 of the communication node 212 is preferably connected to the VRU server 234 and the LAN 240. The VRU client 232 processes speech communications, DTMF tones, pages, and messages (i.e., emails) from the user. Upon receiving speech communications from the user, the VRU client 232 routes the speech communications to the VRU server 234. When the VRU client 232 detects DTMF tones, the VRU client 232 sends a command to the call control unit 236. It will be recognized that the VRU client 232 can be integrated with the VRU server.

The VRU client 232 preferably comprises a computer, such as, a Windows NT compatible computer with hardware capable of connecting individual telephone lines directly to the switch 230 or carrier network 216. The VRU client preferably includes a microprocessor, random access memory, read-only memory, a T1 or ISDN interface board, and one or more voice communication processing board (not shown). The voice communication processing boards of the VRU client 232 are preferably Dialogic boards, Model No. Antares, available from Dialogic Corporation, 1515 Route 10, Parsippany, N.J. 07054. The voice communication boards may include a voice recognition engine having a vocabulary for detecting a speech pattern (i.e., a key word or phrase). The voice recognition engine is preferably a RecServer software package, available from Nuance Communications, 1380 Willow Road, Menlo Park, Calif. 94025.

The VRU client 232 can also include an echo canceler (not shown) to reduce or cancel text-to-speech or playback echoes transmitted from the PSTN 214 due to hybrid impedance mismatches. The echo canceler is preferably included in an Antares Board Support Package, available from Dialogic.

The call control unit 236 of the communication node 212 is preferably connected to the LAN 240. The call control unit 236 sets up the telephone switch 230 to connect incoming calls to the VRU client 232. The call control unit also sets up incoming calls or pages into the node 212 over the internet 220 and pages and messages sent from the communication devices 201 and 203 via the paging network 203 and e-mail system 213. The control call unit 236 preferably comprises a computer, such as, a Window NT compatible computer.

The LAN 240 of the communication node 212 allows the various components and devices of the node 212 to communicate with each other via a twisted pair, a fiber optic cable, a coaxial cable, or the like. The LAN 240 may use Ethernet, Token Ring, or other suitable types of protocols. The LAN 240 is preferably a 100 Megabit per second Ethernet switch, available from Cisco Systems, San Jose, Calif. It will be recognized that the LAN 240 can comprise any suitable network system, and the communication node 212 may include a plurality of LANs.

The VRU server 234 of the communication node 212 is connected to the VRU client 232 and the LAN 240. The VRU server 234 receives speech communications from the user via the VRU client 232. The VRU server 234 processes the speech communications and compares the speech communications against a vocabulary or grammar stored in the database server unit 244 or a memory device. The VRU server 234 provides output signals, representing the result of the speech processing, to the LAN 240. The LAN 240 routes the output signal to the call control unit 236, the application server 242, and/or the voice browser 250. The communication node 212 then performs a specific function associated with the output signals.

The VRU server 234 preferably includes a text-to-speech (TTS) unit 252, an automatic speech recognition (ASR) unit 254, and a speech-to-text (STT) unit 256. The TTS unit 252 of the VRU server 234 receives textual data or information (i.e., e-mail, web pages, documents, files, etc.) from the application server unit 242, the database server unit 244, the call control unit 236, the gateway server 246, the application server 242, and the voice browser 250. The TTS unit 252 processes the textual data and converts the data to voice data or information.

The TTS unit 252 can provide data to the VRU client 232 which reads or plays the data to the user. For example, when the user requests information (i.e., news updates, stock information, traffic conditions, etc.), the communication node 212 retrieves the desired data (i.e., textual information) from a destination of the one or more of the information sources and converts the data via the TTS unit 252 into a response.

The response is then sent to the VRU client 232. The VRU client processes the response and reads an audio message to the user based upon the response. It is contemplated that the VRU server 234 can read the audio message to the user using human recorded speech or synthesized speech. The TTS unit 252 is preferably a TTS 2000 software package, available from Lernout and Hauspie Speech Product NV, 52 Third Avenue, Burlington, Mass. 01803.

The ASR unit 254 of the VRU server 234 provides speaker dependent or independent automatic speech recognition of speech inputs or communications from the user. It is contemplated that the ASR unit 254 can include speaker dependent speech recognition. The ASR unit 254 processes the speech inputs from the user to determine whether a word or a speech pattern matches any of the grammars or vocabulary stored in the database server unit 244 or downloaded from the voice browser. When the ASR unit 254 identifies a selected speech pattern of the speech inputs, the ASR unit 254 sends an output signal to implement the specific function associated with the recognized voice pattern. The ASR unit 254 is preferably a speaker independent speech recognition software package, Model No. RecServer, available from Nuance Communications. It is contemplated that the ASR unit 254 can be any suitable speech recognition unit to detect voice communications from a user.

The STT unit 256 of the VRU server 234 receives speech inputs or communications from the user and converts the speech inputs to textual information (i.e., a text message). The textual information can be sent or routed to the communication devices 201, 202, 203 and 204, the content providers 208 and 209, the markup language servers, the voice browser, and the application server 242. The STT unit 256 is preferably a Naturally Speaking software package, available from Dragon Systems, 320 Nevada Street, Newton, Mass. 02160-9803.

The VOIP unit 248 of the telecommunication node 212 is preferably connected to the telephone switch 230 and the LAN 240. The VOIP unit 248 allows a user to access the node 212 via the Internet 220 or VOIP public network using voice commands. The VOIP unit 240 can receive VOIP protocols (i.e., H.323 protocols) transmitted over the Internet 220 or intranet and can convert the VOIP protocols to speech information or data. The speech information can then be read to the user via the VRU client 232. The VOIP unit 248 can also receive speech inputs or communications from the user and convert the speech inputs to a VOIP protocol that can be transmitted over the Internet 220. The VOIP unit 248 is preferably a Voice Net software package, available from Dialogic Corporation. It will be recognized that the VOIP device can be incorporated into a communication device.

The telecommunication node 212 also includes a detection unit 260. The detection unit 260 is preferably a phrase or key word spotter unit to detect incoming audio inputs or communications or DTMF tones from the user. The detector unit 260 is preferably incorporated into the switch 230, but can be incorporated into the VRU client 232, the carrier switch 216, or the VRU server 256. The detection unit 260 is preferably included in a RecServer software package, available from Nuance Communications.

The detection unit 260 records the audio inputs from the user and compares the audio inputs to the vocabulary or grammar stored in the database server unit 244. The detector unit continuously monitors the user's audio inputs for a key phase or word after the user is connected to the node 212. When the key phrase or word is detected by the detection unit 260, the VRU client 232 plays a pre-recorded message to the user. The VRU client 232 then responds to the audio inputs provided by the user.

The billing server unit 238 of the communication node 212 is preferably connected to the LAN 240. The billing server unit 238 can record data about the use of the communication node by a user (i.e., length of calls, features accessed by the user, etc.). Upon completion of a call by a user, the call control unit 236 sends data to the billing server unit 238. The data can be subsequently processed by the billing server unit in order to prepare customer bills as described above. The billing server unit 238 can use the ANI or CLI of the communication device to properly bill the user. The billing server unit 238 preferably comprises a Windows NT compatible computer.

The gateway server unit 246 of the communication node 212 is preferably connected to the LAN 240 and the Internet 220. The gateway server unit 246 provides access to the content provider 208 and the markup language server 257 via the Internet 220. The gateway unit 246 also allows users to access the communication node 212 from the communication device 204 via the Internet 220. The gateway unit 246 can further function as a firewall to control access to the communication node 212 to authorized users. The gateway unit 246 is preferably a Cisco Router, available from Cisco Systems, San Jose, Calif.

The database server unit 244 of the communication node 212 is preferably connected to the LAN 240. The database server unit 244 preferably includes a plurality of storage areas to store data relating to users, speech vocabularies, dialogs, personalities, user entered data, and other information. Preferably, the database server unit 244 stores a personal file or address book. The personal address book can contain information required for the operation of the system, including user reference numbers, personal access codes, personal account information, contact's addresses, and phone numbers, etc. The database server unit also stores user data, such as the user's home phone number, address, billing information, etc. The database server unit 244 is preferably a computer, such as an NT Window compatible computer.

The application server 242 of the communication node 212 is preferably connected to the LAN 240 and the content provider 209. The application server 242 allows the communication node 212 to access information from a destination of the information sources, such as the content providers and markup language servers. For example, the application server can retrieve information (i.e., weather reports, stock information, traffic reports, restaurants, flower shops, banks, calendars, “to-do” lists, e-commerce, etc.) from a destination of the information sources. This application server may include Starfish Software to provide the address book, calendar, and to-do lists and allow the user to organize information. The application server 242 processes the retrieved information and provides the information to the VRU server 234 and the voice browser 250. The VRU server 234 can provide an audio announcement to the user based upon the information using text-to-speech synthesizing or human recorded voice. The application server 242 can also send tasks or requests (i.e., transactional information) received from the user to the information sources (i.e., a request to place an order for a pizza). The application server 242 can further receive user inputs from the VRU server 234 based upon a speech recognition output. The application server is preferably a computer, such as an NT Windows compatible computer.

The voice markup language server 251 of the communication node 212 is preferably connected to the LAN 240. The markup language server 251 can include a database, scripts, and markup language documents or pages. The data markup language server 253 of the communication node 212 is also preferably connected to the LAN 240. The voice and date markup language servers 251 and 253 are preferably computers, such as an NT Window Compatible Computers. It will also be recognized that the markup language server 251 can be an Internet server (i.e., a Sun Microsystems server).

The messaging server 255 of the communication node 212 is preferably connected to the LAN 240, the paging network 211, an E-Mail system 285, and a short message system 290. The messaging server 255 routes pages between the LAN 240 and the paging network. The messaging server 255 is preferably a computer, such as an NT compatible computer. The message server can also provide email storage. It is contemplated that the messaging server 255 can reside externally from the node. The messaging server can further include Exchange Server software from Microsoft Corporation.

The voice browser 250 of the system 200 is preferably connected to the LAN 240. The voice browser 250 preferably receives information from the information sources, such as the content provider 209 via the application server 242, the data and voice markup language servers 251 and 257, the database 244, and the content provider 208, 209. In response to voice inputs from the user or DTMF tones, the voice browser 250 generates a content request (i.e., an electronic address) to navigate to a destination of one or more of the information sources. The content request can use at least a portion of a URL, an URN, an IP, a page request, or an electronic e-mail.

After the voice browser is connected to an information source, the voice browser preferably uses a TCP/IP connection to pass requests to the information source. The information source responds to the requests, sending at least a portion of the requested information, represented in electronic form, to the voice browser. The information can be stored in a database of the information source and can include text content, markup language document or pages, non-text content, dialogs, audio sample data, recognition grammars, etc. The voice browser then parses and interprets the information as further described below. It will be recognized that the voice browser can be integrated into the communication devices 201, 202, 203, and 204.

As shown in FIG. 8, the content provider 208 is connected to the application server 244 of the communication node 212, and the content provider 209 is connected to the gateway server 246 of the communication node 212 via the Internet 220. The content providers can store various content information, such as news, banking, v-commerce, e-commerce, weather, traffic conditions, etc. The content providers 208 and 209 can include a server to operate web pages or documents in the form of a markup language. The content providers 208 and 209 can also include a database, scripts, and/or markup language documents or pages. The scripts can include images, audio, grammars, computer programs, etc. The content providers execute suitable server software to send requested information to the voice browser.

The voice mail unit 274 of the telecommunication node 206 is preferably connected to the telephone switch 203 and the LAN 240. The voice mail unit 274 can store voice mail messages from users or other parties trying to send messages to users of the node. When a user accesses the telecommunication node 206, the voice mail unit 274 can notify the user of new and stored messages. The user can access the messages to play, delete, store and forward the messaged. When the user accesses a message, the message can be read to the user or can be displayed as textual information on a communication device (i.e., a pager, a SMS, or a PDA, etc.). The user can also access and operate external messages or mail systems remote from the telecommunication node 206.

The fax server unit 272 of the telecommunication node 206 is preferably connected to the telephone switch 230 and the LAN 240. The fax server unit 272 receivers and stores facsimile information sent via the electronic network 220 or the carrier switch 216. The users can access the facsimile information to play, store, delete, and forward the information. The facsimile information can be read to the user via the TTS unit 252 or can be displayed as textual information on a suitable communication device. The fax server unit 272 preferably comprises a computer such as, an NT compatible computer or a Dialogue Fax Server.

Further information regarding the communication system 200 is disclosed in U.S. patent application Ser. No. 09/141,485 entitled Telecommunication System and Methods therefor, filed Aug. 27, 1998, the entire disclosure of which is incorporated herein.

It should be appreciated that the embodiments described above are to be considered in all respects only illustrative and not restrictive. The scope of the invention is indicated by the following claims rather than by the foregoing description. All changes that come within the meaning and range of equivalents are to be embraced within their scope.

We claim:

1. A method of transferring a call across networks of a transport system, the transport system capable of providing a connection between a communication node and first, second and third communication devices, the method comprising the steps of:
connecting the first communication device to the communication node over a first network of the transport system;
connecting the second communication device with the first communication device;
in response to a command received over the first network, establishing a connection between the third communication device and the communication node over a second network of the transport system, the second network being different than the first network; and
connecting the second communication device to the third communication device.

2. The method of claim 1, wherein the establishing step includes:
placing the call from the communication node to the third communication device over the second network.

3. The method of claim 1, wherein the establishing step includes:
receiving a call from a third communication device via the second network.

4. The method of claim 1, further comprising the step of disconnecting the first communication device from the communication node.

5. The method of claim 2, further comprising the step of disconnecting the first communication device from the communication node after placing the call to the third communication device.

6. The method of claim 2, further comprising the step of disconnecting the first communication device from the communication node prior to placing the call to the third communication device.

7. The method of claim 2, further comprising the step of receiving a signal from the third communication device to connect the communication node to the third communication device via the second network.

8. The method of claim 2, further comprising the step of receiving a signal from the fourth communication device to connect the communication node to the third communication device via the second network.

9. The method of claim 1, further comprising the step of receiving a signal from a fourth communication device to connect the communication node to the fourth communication device via the second transport system prior to connecting the second communication device to the third communication device.

10. The method of claim 2, further comprising the step of comparing a signal with an instruction set associated with the communication node, wherein the signal comprises a set of inband and out of band signals.

11. The method of claim 1, wherein the first and second networks include one of a Public Switched Telephone Network, a cellular network, a satellite system, a wireless local loop network, a paging network, an Internet, and a Voice Over Internet Protocol network.

12. The method of claim 1, wherein the first, second and third communication devices include one of a telephone, a satellite telephone, a paging unit, a computer, a personal digital assistant, and a cellular telephone.

13. A system for transferring a call across networks of a transport system, the transport system capable of providing a connection between a communication node and first, second and third communication devices, the method, comprising:
computer readable program code to establish a connection over a first network of the transport system between the first communication device and the communication node;
computer readable program code to connect the first communication device to the second communication device;
computer readable program code to establish a connection over a second network between the third communication device and the communication node, the second network being different than the first network; and
computer readable program code to connect the third communication device to the second communication device.

14. The system of claim 13 further comprising computer readable program code to place a call to the third communication device.

15. The system of claim 13 further comprising computer readable program code to receive a call from a third communication device.

16. The system of claim 13, further comprising:
computer readable program code to disconnect the first communication device from the communication node.

17. The system of claim 13, further comprising:
computer readable program code to receive a signal from the third communication device to connect the communication node to the third communication device via the second network.

18. The system of claim 13, further comprising:
computer readable program code to receive a signal from a fourth communication device to connect the communication node to the fourth communication device via the second network prior to connecting the second communication device to the third communication device.

19. The system of claim 13 comprising:
computer readable code to receive a signal from the fourth communication device to connect the communication node to the third communication device via the second network.

20. The system of claim 13, further comprising:
computer readable program code to establish a connection between the third communication device and the first and second communication devices.

21. The system of claim 13, further comprising:
computer readable program code to compare the signal, which comprises a set of inband and out of band signals, with an instruction set associated with the communication node.

22. A program for transferring a call across networks of a transport system, the transport system capable of providing a connection between a communication node and first, second and third communication devices, the method, comprising:
computer readable program code to establish a connection over a first network of the transport system between the first communication device and the communication node;
computer readable program code to connect the first communication device to the second communication device;
computer readable program code to establish a connection over a second network between the third communication device and the communication node; and
computer readable program code to connect the third communication device to the second communication device.

23. The program of claim 22 further comprising: computer readable program code to place the call from the communication node to the third communication device via the second transport system.

24. The program of claim 22 further comprising:
computer readable program code to receive a call from a third communication device via a second transport system to the communication node.

25. A method of transferring a call comprising the steps of:
establishing a first communication channel over a first network with a first party;
establishing a second communication channel with a second party;
linking the first communication channel to the second communication channel so that the first and second party can communicate;
establishing a third communication channel over a second network with the first party without human operator assistance, the second network being different than the first network; and
linking the third communication channel to the to the first communication channel so that the first party can communicate with the second party over the second network.

26. A method of transferring a call comprising the steps of:
establishing a first connection over a first network between an electronic assistant and a first party;
connecting the first party to a second party so that they may communicate with each other over the first connection;
in response to receiving a transfer command, establishing a second connection over a second network between the first party and the electronic assistant, the second network being different than the first network; and
linking the first party to the second party can communicate over the second network.

27. In a cellular network, a method of transferring a call comprising the steps of:
establishing a first connection over a first network between a communication node and a first party;
connecting the first party to a second party so that they may communicate with each other over the first connection;
in response to receiving a command from the first party, establishing a second connection over a second network between the first party and the communication node, the second network being different than the first network; and
linking the first party to the second party so that the first party and second party can communicate over the second network.
